(19) United States
(12) Patent Application Publication
(10) Pub. No.: US 2025/0083184 A1
(43) Pub. Date: Mar. 13, 2025

(54) METHOD FOR FORMING TWO-COLOR COATING LAYER

(71) Applicant: GIANT GLORY INTERNATIONAL LIMITED, Apia (WS)

(72) Inventors: Shun-Jie YANG, New Taipei City (TW); Hsiang-Jui WANG, Taoyuan City; (TW); Chi-Heng LIU, New Taipei City (TW); Cheng-Ping HSIAO, Changzhi Township (TW)

(21) Appl. No.: 18/611,814

(22) Filed: Mar. 21, 2024

(30) Foreign Application Priority Data
Sep. 8, 2023 (TW) 112134308

(51) Int. Cl. B05D 5/06; B05D 1/32; B05D 3/02; B05D 3/06

(52) U.S. Cl. CPC B05D 5/06; B05D 1/32; B05D 3/0272; B05D 3/067

(57) ABSTRACT

A method for forming a two-color coating layer includes steps of: a) conducting a coating process by applying a coating layer on a workpiece having a stepped surface, so that the coating layer having a first color is formed on the stepped surface, the stepped surface having a lower region, an upper region, and a middle shoulder region; b) forming an ink layer that has a second color and that covers the coating layer; c) soft baking the ink layer; d) exposing to light a first area of the ink layer so that the first area undergoes a crosslinking reaction; e) developing the ink layer so that a second area of the ink layer is removed; and f) hard baking the ink layer, wherein the stepped surface has the second color formed on the lower and middle shoulder regions, and the first color formed on the upper region.

### CROSS-REFERENCE TO RELATED APPLICATION

This application claims priority to Taiwanese Invention Patent Application No. 112134308, filed on Sep. 8, 2023, the entire disclosure of which is incorporated by reference herein.

### FIELD

The disclosure relates to a method for forming a coating layer, and more particularly to a method for forming a two-color coating layer.

### BACKGROUND

With the progress of the technology industry, the demand for consumer electronics, such as computers and peripherals thereof, is becoming increasingly greater. The design of the appearance of these consumer electronics is becoming important as consumers are paying greater attention to it. As a result, the aesthetics of the shells of these consumer electronics (e.g., cell phones, laptops, tablets, and keyboards) have received much attention.

For example, a keyboard shell (not shown) of a laptop is generally divided into a keyboard area and a non-keyboard area. The keyboard area refers to an area of a keyboard that has a plurality of through holes for disposition of keyboard keys. The non-keyboard area refers to another area of the keyboard that extends backwardly from the through holes and that is adapted for a touch pad to be disposed or for a user's wrist to be rested thereon. When a screen of the laptop is not lifted, the screen faces the keyboard to keep the laptop in a closed state. To prevent the laptop from not closing properly due to the keyboard keys protruding from the through holes in the closed state, the keyboard shell is usually designed to have a height difference between the keyboard area and the non-keyboard area. That is to say, the keyboard shell has a stepped surface with a lower region, an upper region, and a middle shoulder region that connects the lower region to the upper region.

To satisfy consumer demand for the aesthetics of the laptops, the keyboard area and the non-keyboard area are designed to have different colors so as to be visually pleasing. Currently, there are two methods for forming colors on the keyboard shell.

The first method involves covering the keyboard area or the non-keyboard area with a mask so that the area that is not covered is formed with a color. This method may deliver a keyboard shell having two colors, but a gap may exist in the middle shoulder region, which is not formed with a color due to the stepped surface, thereby affecting the overall appearance of the keyboard shell.

The second method involves using a charge coupled device (CCD), software calculation, and jet printing equipment to perform position aligning, color switching, and printing the keyboard shell, so that there is no gap on the stepped surface of the keyboard shell. Although the second method may resolve some issues of the first method, the second method is more expensive due to equipment cost.

Therefore, providing an improved method for forming colors with no gap on the stepped surface while reducing costs is thus the issue at hand.

### SUMMARY

Therefore, an object of the disclosure is to provide a method for forming a two-color coating layer that can alleviate at least one of the drawbacks of the prior art.

According to the disclosure, the method includes steps of:
a) conducting a coating process by applying a coating layer on a workpiece that has a stepped surface, so that the coating layer that has a first color is formed on the stepped surface of the workpiece, wherein the stepped surface has a lower region, an upper region that is higher than the lower region, and a middle shoulder region that connects the lower region and the upper region;
b) after step a), forming an ink layer that has a second color and that covers the coating layer formed on all of the lower region, the upper region, and the middle shoulder region of the stepped surface;
c) soft baking the ink layer from step b);
d) exposing to light a first area of the ink layer from step c) so that the first area of the ink layer undergoes a crosslinking reaction, wherein the first area of the ink layer corresponds to the lower region of the stepped surface and the middle shoulder region of the stepped surface;
e) developing the ink layer from step d) so that a second area of the ink layer, which is unexposed to light, is removed, thereby exposing the first color of the coating layer formed on the upper region of the stepped surface, wherein the second area of the ink layer is not crosslinked and corresponds to the upper region of the stepped surface; and
f) hard baking the ink layer from step e), wherein the stepped surface has the second color formed on the lower region of the stepped surface and the middle shoulder region of the stepped surface, and the first color formed on the upper region of the stepped surface.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating step a) in a method for forming a two-color coating layer of an embodiment according to the disclosure.

FIG. 2 is a schematic view illustrating step b) of the embodiment according to the disclosure.

FIG. 3 is a schematic view illustrating step c) of the embodiment according to the disclosure.

FIG. 4 is a schematic view illustrating step d) of the embodiment according to the disclosure.

FIG. 5 is a schematic view illustrating step e) of the embodiment according to the disclosure.

FIG. 6 is a schematic view illustrating step f) of the embodiment according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

According to an embodiment of the disclosure, a method for forming a two-color coating layer is adapted for forming the two-color coating layer on a shell (i.e., a workpiece 2) of a keyboard of a laptop, and includes step a), step b), step c), step d), step e), and step f).

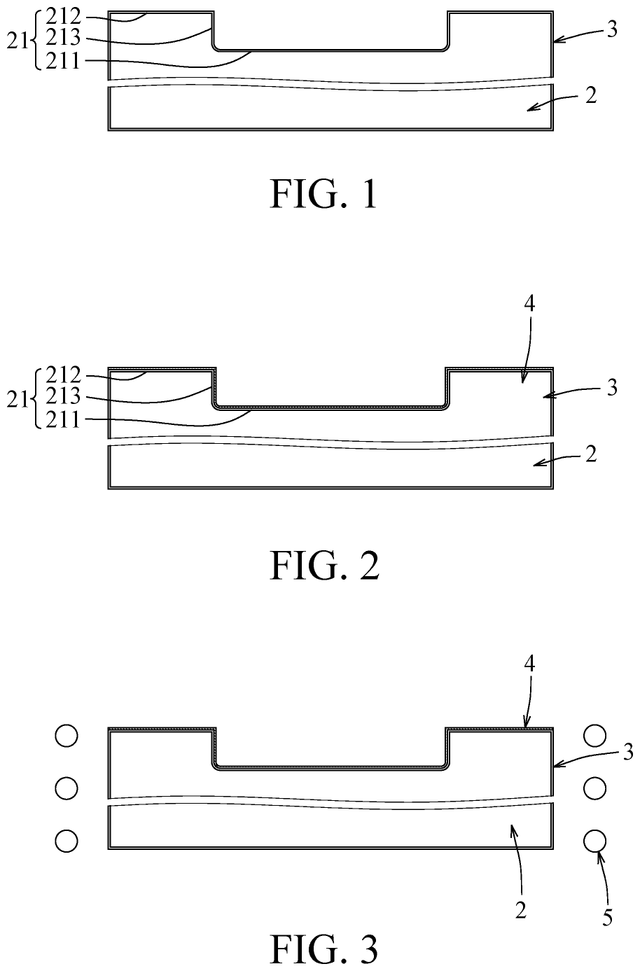

Referring to FIG. 1, step a) involves conducting a coating process by applying a coating layer 3 on the workpiece 2 that has a stepped surface 21, so that the coating layer 3 that has a first color is formed on the stepped surface 21 of the workpiece 2. The stepped surface 21 has a lower region 211, an upper region 212 that is higher than the lower region 211, and a middle shoulder region 213 that connects the lower region 211 and the upper region 212. In some embodiments, in step a), the workpiece 2 is made of one of aluminum alloy, magnesium alloy, stainless steel, titanium, plastic, and combinations thereof. The coating process is one of an anodic treatment, electroplating, electrostatic coating, physical vapor deposition, and spray painting. In this embodiment, the workpiece 2 is made of aluminum alloy, and the coating process is implemented by conducting the anodic treatment, but is not limited to. The coating layer 3 having the first color after step a) is an aluminum oxide layer that has a thickness ranging from 8 μm to 15 μm.

Referring to FIG. 2, step b) involves forming an ink layer 4 that has a second color and that covers the coating layer 3 formed on all of the lower region 211, the upper region 212, and the middle shoulder region 213 of the stepped surface 21.

Referring to FIG. 3, step c) involves soft baking the ink layer 4 from step b). Specifically, in step c), the ink layer 4 from step b) is soft baked at a first temperature ranging from 90° C. to 120° C. for a first period ranging from 5 minutes to 15 minutes.

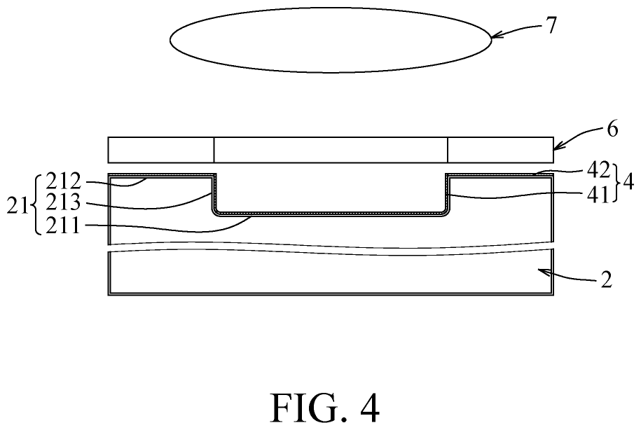

Referring to FIG. 4, step d) involves exposing to light a first area 41 of the ink layer 4 from step c) so that the first area 41 of the ink layer 4 undergoes a crosslinking reaction, where the first area 41 of the ink layer 4 corresponds to the lower region 211 of the stepped surface 21 and the middle shoulder region 213 of the stepped surface 21. Specifically, a photomask 6 that exposes the first area 41 of the ink layer 4 to an ultraviolet light beam 7 is disposed above the workpiece 2 that is formed with the coating layer 3 and the ink layer 4. The ultraviolet light beam 7 is disposed above the photomask 6, and the first area 41 of the ink layer 4 that is not covered by the photomask 6 is thus exposed to the ultraviolet light beam 7, thereby enabling the first area 41 of the ink layer 4 to undergo the crosslinking reaction, so that the first area 41 of the ink layer 4 may not be removed in the next step.

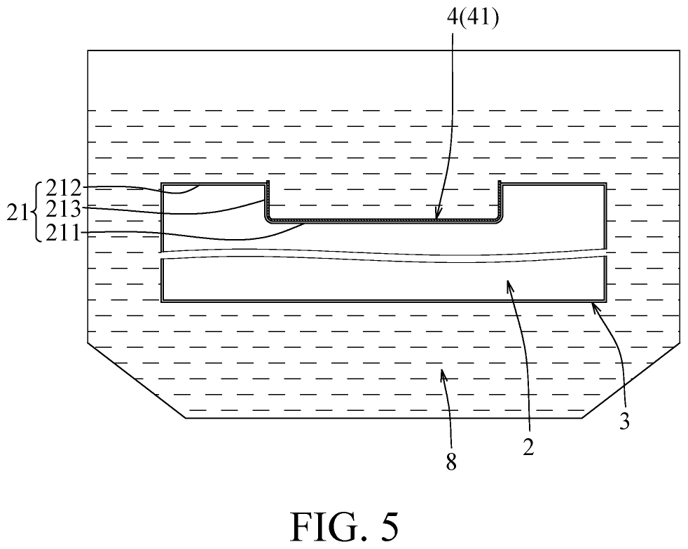

Referring to FIG. 5, step e) involves developing the ink layer 4 from step d) so that a second area 42 of the ink layer 4, which is unexposed to the light, is removed, thereby exposing the first color of the coating layer 3 formed on the upper region 212 of the stepped surface 21, wherein the second area 42 of the ink layer 4 is not crosslinked and corresponds to the upper region 212 of the stepped surface 21. It should be noted that, to prevent the first color of the coating layer 3 that is formed on the upper region 212 of the stepped surface 21 from being damaged when developing the ink layer 4, in some embodiments, in step e), the ink layer 4 is developed by using a weak alkaline developer 8 to treat the second area 42 of the ink layer 4 (i.e., the upper region 212 of the stepped surface 21). Specifically, referring to FIG. 5, step e) involves immersing the ink layer 4 from step d) in the weak alkaline developer 8, so as to dissolve the ink layer 4 that is formed on the upper region 212 of the stepped surface 21 and that is not crosslinked in the weak alkaline developer 8, thereby removing the ink layer 4 that is formed on the upper region 212 of the stepped surface 21 and that is not crosslinked.

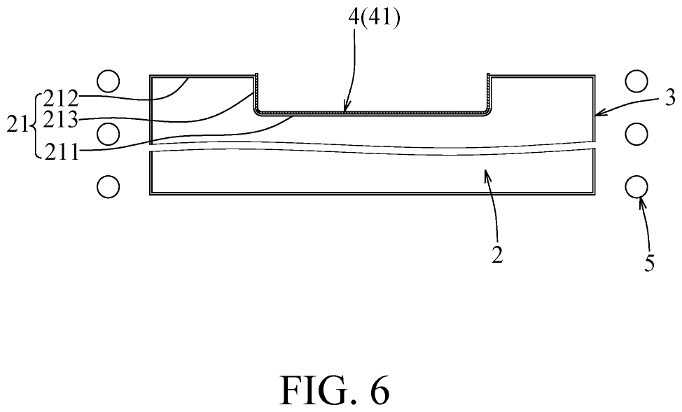

Referring to FIG. 6, step f) involves hard baking the ink layer 4 from step e), so that the stepped surface 21 has the second color formed on the lower region 211 of the stepped surface 21 and the middle shoulder region 213 of the stepped surface 21, and the first color formed on the upper region 212 of the stepped surface 21. Specifically, step f) involves hard baking the ink layer 4 from step e) in an oven 5. In some embodiments, in step f), the ink layer 4 from step e) is hard baked at a second temperature ranging from 140° C. to 160° C. for a second period no shorter than one hour.

It should be noted that, in the method for forming the two-color coating layer, the stepped surface 21 having the first color of the coating layer 3 and the second color of the ink layer 4 is realized by removing the second area 42 of the ink layer 4 (i.e., corresponding to the upper region 212 of the stepped surface 21) from a portion of the coating layer 3 covering the upper region 212 of the stepped surface 21. After removal of the second area 42 of the ink layer 4, the second color of the ink layer 4 remains on the lower region 211 of the stepped surface 21 and the middle shoulder region 213 of the stepped surface 21. To prevent the first color of the coating layer 3 on the upper region 212 and the remaining second color of the ink layer 4 from having a height difference which is not visually pleasing, in some embodiments, in step b), the ink layer 4 has a thickness that ranges from 5 μm to 8 μm, which does not create a significant height difference that is noticeable by naked eye.

As can be seen from the above detailed description of the embodiment of the disclosure, the ink layer 4 that has the second color is formed on all part of the coating layer 3 formed on all of the lower region 211, the upper region 212, and the middle shoulder region 213 of the stepped surface 21. Therefore, after the method of the disclosure is implemented, the ink layer 4 remaining on the coating layer 3 is an unterruptedly continuous layer formed on the lower region 211 and the middle shoulder region 213 of the stepped surface 21, thereby resolving a gap problem between colors on the stepped surface 21. In addition, the thickness of the ink layer 4 is microscopic, so consumers may not be able to notice the height difference between the first color of the coating layer 3 and the second color of the ink layer 4. Furthermore, the embodiment of the disclosure may be implemented by using only a low level lithography equipment device, which costs less compared to equipment used for forming a two-color coating layer in prior art. Thus, the purpose of this disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for forming a two-color coating layer, comprising steps of:
a) conducting a coating process by applying a coating layer on a workpiece that has a stepped surface, so that the coating layer that has a first color is formed on the stepped surface of the workpiece, wherein the stepped surface has a lower region, an upper region that is higher than the lower region, and a middle shoulder region that connects the lower region and the upper region;
b) after step a), forming an ink layer that has a second color and that covers the coating layer formed on all of the lower region, the upper region, and the middle shoulder region of the stepped surface;
c) soft baking the ink layer from step b);
d) exposing to light a first area of the ink layer from step c) so that the first area of the ink layer undergoes a crosslinking reaction, wherein the first area of the ink layer corresponds to the lower region of the stepped surface and the middle shoulder region of the stepped surface;
e) developing the ink layer from step d) so that a second area of the ink layer, which is unexposed to light, is removed, thereby exposing the first color of the coating layer formed on the upper region of the stepped surface, wherein the second area of the ink layer is not crosslinked and corresponds to the upper region of the stepped surface; and
f) hard baking the ink layer from step e), wherein the stepped surface has the second color formed on the lower region of the stepped surface and the middle shoulder region of the stepped surface, and the first color formed on the upper region of the stepped surface.

2. The method for forming a two-color coating layer as claimed in claim 1, wherein in step a), the workpiece is made of one of aluminum alloy, magnesium alloy, stainless steel, titanium, plastic, and combinations thereof.

3. The method for forming a two-color coating layer as claimed in claim 1, wherein in step a), the coating process is one of an anodic treatment, electroplating, electrostatic coating, physical vapor deposition, and spray painting.

4. The method for forming a two-color coating layer as claimed in claim 1, wherein in step b), a thickness of the ink layer ranges from 5 μm to 8 μm.

5. The method for forming a two-color coating layer as claimed in claim 1, wherein in step c), the ink layer from step b) is soft baked at a first temperature ranging from 90° C. to 120° C. for a first period ranging from 5 minutes to 15 minutes.

6. The method for forming a two-color coating layer as claimed in claim 1, wherein in step e), the ink layer is developed by using a weak alkaline developer to treat the second area of the ink layer.

7. The method for forming a two-color coating layer as claimed in claim 1, wherein in step f), the ink layer from step e) is hard baked at a second temperature ranging from 140° C. to 160° C. for a second period no shorter than one hour.
